(19) United States
(12) Patent Application Publication
(10) Pub. No.: US 2014/0370835 A1
(43) Pub. Date: Dec. 18, 2014

(54) Method of Handling Radio Resource Control Connection Establishment during Reception of Public Warning System Message in Wireless Communication System and Communication Device Thereof

(71) Applicant: HTC Corporation, Taoyuan County (TW)

(72) Inventor: Chih-Hsiang Wu, Taoyuan County (TW)

(21) Appl. No.: 14/300,236

(22) Filed: Jun. 10, 2014

Related U.S. Application Data
(60) Provisional application No. 61/834,892, filed on Jun. 14, 2013.

(51) Int. Cl. H04W 4/22

(52) U.S. Cl. CPC H04W 4/22
USPC 455/404.1

(57) ABSTRACT

A method of handling radio resource control (RRC) connection establishment during reception of a public warning system (PWS) message for a user equipment of a wireless communication system includes starting to receive the PWS message; determining to initiate an RRC connection establishment procedure for initiating a high priority packet-switched (PS) service during the reception of the PWS message broadcast by system information or a cell broadcast service (CBS); and determining not to initiate an RRC connection establishment procedure for initiating a PS service other than the high priority PS service during the reception of the PWS message broadcast by the system information or the CBS.

### CROSS REFERENCE TO RELATED APPLICATIONS

This application claims the benefit of U.S. Provisional Application No. 61/834,892, filed on Jun. 14, 2013 and entitled “Method and Apparatus for improving reception of PWS message in a wireless communication system”, the contents of which are incorporated herein by reference.

### BACKGROUND OF THE INVENTION

1. Field of the Invention

The present invention relates to a method utilized in a wireless communication system and a communication device thereof, and more particularly, to a method of handling radio resource control connection establishment during reception of a public warning system message in a wireless communication system and a communication device thereof.

2. Description of the Prior Art

The 3rd Generation Partnership Project (3GPP) has developed a universal mobile telecommunications system (UMTS) which adopts a wideband code division multiple access (WCDMA) as a wireless air interface. In the UMTS, a radio access network known as a universal terrestrial radio access network (UTRAN) includes multiple NodeBs (NBs) for communicating with multiple user equipments (UEs) (i.e., mobile stations (MSs)). The UMTS supports both a packet-switched (PS) service and a circuit-switched (CS) service, and provides high frequency spectrum utilization, universal coverage, and high-speed multimedia data transmission.

Public Warning System (PWS), e.g. Earthquake and Tsunami Warning System (ETWS), set forth by the 3GPP, is a natural disaster warning system for delivering warning notification simultaneously to many mobile users who should evacuate from approaching natural disasters such as earthquake, tsunami or landslide. The PWS consists of a PLMN (Public Land Mobile Network) that is capable to deliver warning notification and the UEs that are capable to receive warning notification. The PLMN of the PWS can be a GERAN (GSM/EDEG radio access network) of a 2G/2.5G GSM system, a UTRAN of a 3G UMTS system, or a EUTRAN (evolved-UTAN) of a long term evolution (LTE) system. Warning notification providers, which are usually run by local governments, produce warning notification to PLMN operator when a natural disaster event occurs.

In the prior art, a PWS capable UE in an idle mode is capable of receiving warning notification broadcast by system information or cell broadcast service (CBS). The system information is transmitted by a broadcast control channel (BCCH) in the UMTS system and GSM system. The CBS is transmitted by a common traffic channel (CTCH) in the UMTS system and by a cell broadcast channel (CBCH) in the GSM system. However, the PWS capable UE is not allowed to be in a radio resource control (RRC) connected mode when the PWS capable UE is receiving the system information or the CBS. In general, a user of the PWS capable UE who receives the warning notification may desire to make a CS phone call, in order to inform his/her friends or relatives about the situation in disaster areas. The 3GPP specification allows the PWS capable UE to access a CS service when the PWS capable UE is receiving the warning notification. Hence the PWS capable UE immediately performs RRC connection establishment for making the CS phone call during reception of the warning notification. However, if the user needs to make a phone call via Voice over Internet Protocol (VoIP) (e.g. the Internet protocol multimedia subsystem (IMS) call), making this phone call in PS domain may be prohibited or postponed until the reception of the warning notification finishes, which troubles the user of the PWS capable UE. In addition, several low priority CS services are also allowed during the reception of the warning notification. Thus, there is a need for improvement over the prior art.

### SUMMARY OF THE INVENTION

It is therefore an objective of the present invention to provide a method of handling radio resource control (RRC) connection establishment during reception of a public warning system (PWS) message for a wireless communication system and a communication device thereof to solve the abovementioned problem.

An embodiment of the present invention discloses a method of handling RRC connection establishment during reception of a PWS message for a user equipment of a wireless communication system. The method comprises starting to receive the PWS message; determining to initiate an RRC connection establishment procedure for initiating a high priority packet-switched (PS) service during the reception of the PWS message broadcast by system information or a cell broadcast service (CBS); and determining not to initiate an RRC connection establishment procedure for initiating a PS service other than the high priority PS service during the reception of the PWS message broadcast by the system information or the CBS.

An embodiment of the present invention further discloses a communication device of a wireless communication system for handling RRC connection establishment during reception of a PWS message. The communication device comprises a processing means and a storage unit. The processing means is utilize for executing a program. The storage unit, coupled to the processing means, is utilized for storing the program which instructs the processing means to perform the following steps: starting to receive the PWS message; determining to initiate an RRC connection establishment procedure for initiating a high priority PS service during the reception of the PWS message broadcast by system information or a CBS; and determining not to initiate an RRC connection establishment procedure for initiating a PS service other than the high priority PS service during the reception of the PWS message broadcast by the system information or the CBS.

An embodiment of the present invention further discloses a communication device of a wireless communication system for handling RRC connection establishment during reception of a PWS message. The communication device comprises a processing means and a storage unit. The processing means is utilized for executing a program. The storage unit, coupled to the processing means, is utilized for storing the program which instructs the processing means to perform the following steps: starting to receive the PWS message; determining not to initiate an RRC connection establishment procedure for initiating a low priority circuit-switched (CS) service during the reception of the PWS message broadcast by system information or a CBS; and determining to initiate an RRC connection establishment procedure for initiating a CS service other than the low priority CS service during the reception of the PWS message broadcast by the system information or the CBS.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the present invention.

FIG. 2 is a schematic diagram of a communication device according to an embodiment of the present invention.

FIG. 3 is a flowchart of a process according to an embodiment of the present invention.

FIG. 4 is a flowchart of a process according to another embodiment of the present invention.

### DETAILED DESCRIPTION

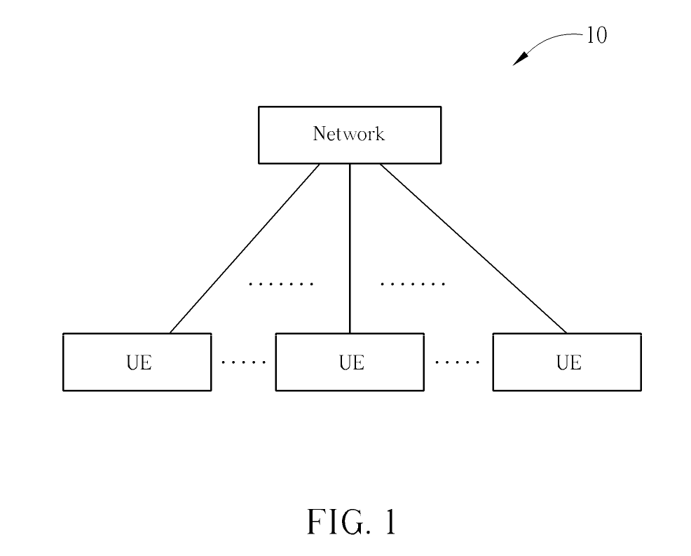

Please refer to FIG. 1, which is a schematic diagram of a wireless communication system 10 according to an embodiment of the present invention. The wireless communication system 10 is a Public Warning System (PWS) based on a 2.5G/3G (Generation) mobile telecommunication system, a universal mobile telecommunications system (UMTS) system or other mobile communication systems, and is briefly composed of a network and a plurality of PWS capable user equipments (UEs). In FIG. 1, the network and the PWS capable UEs are simply utilized for illustrating the structure of the wireless communication system 10. Practically, the network may be a public land mobile network (PLMN), such as a GERAN (GSM/EDEG radio access network) of a 2G/2.5G GSM system or a UTRAN (UMTS radio access network) of a 3G UMTS system, comprising a plurality of base stations (i.e. BTSs or NodeBs), network controllers (i.e. Base Station Controllers or Radio Network Controllers) and so on according to actual demands.

Each of the PWS capable UEs may be a mobile station, a low cost device (e.g., machine type communication (MTC) device), a mobile phone, a laptop, a tablet computer, an electronic book or a portable computer system. In addition, the network and the UE may be seen as a transmitter or a receiver according to direction (i.e. transmission direction), e.g., for an uplink (UL), the UE is the transmitter and the network is the receiver, and for a downlink (DL), the network is the transmitter and the UE is the receiver. More specifically, for the network, the direction of the transmission is DL, and the direction of the reception is UL. For the UE, the direction of the transmission is UL, and the direction of the reception is DL.

The network may deliver a PWS message (e.g. warning notification) to the PWS capable UEs in a broadcast way via system information or cell broadcast service (CBS). Before transmission of the PWS message, the network may first send a paging message to the PWS capable UEs in disaster areas or near disaster areas. The paging message may include an information element (IE) “ETWS information” and an IE “BCCH modification info” in the message PAGING TYPE 1 to indicate there is a warning notification required to be delivered. The IE “ETWS information” indicates that the PWS message may be an earthquake and tsunami warning system (ETWS) message. The IE “BCCH modification info” notifies the UEs that there is an update in the system information in the broadcast control channel (BCCH) . According to the 3GPP specification 3GPP TS 25.331 v11.5.0, if both the IE “ETWS information” and the IE “BCCH modification info” are present in the message PAGING TYPE 1, the PWS capable UEs should set the variable BCCH_MODIFICATION_ACCESS_PROHIBITION to TRUE. In such a condition, the PWS capable UEs in idle mode may not initiate a radio resource control (RRC) connection establishment procedure.

Moreover, according to the 3GPP specification, a PWS capable UE in idle mode is allowed to initiate an RRC connection establishment procedure only when at least one of the following three conditions is met. First, the PWS capable UE is allowed to initiate the RRC connection establishment procedure if the variable BCCH_MODIFICATION_ACCESS_PROHIBITION is set to FALSE; that is, at least one of the IE “ETWS information” and the IE “BCCH modification info” should not be present in the message PAGING TYPE 1. Second, the PWS capable UE is allowed to initiate the RRC connection establishment procedure if the establishment of a signaling connection is requested for CS domain; in other words, the RRC connections for CS services are allowed, but those for PS services are not. Third, the PWS capable UE is allowed to initiate the RRC connection establishment procedure if the variable ESTABLISHMENT_CAUSE is set to “Emergency Call”; that is, the RRC connection is established due to an emergency call. If none of the above three conditions are met, the PWS capable UE is prohibited to initiate the RRC connection establishment procedure.

Note that, if the variable BCCH_MODIFICATION_ACCESS_PROHIBITION is set to TRUE due to the reception of the PWS message, only the emergency call and the CS services are allowed for establishing RRC connection. If the variable BCCH_MODIFICATION_ACCESS_PROHIBITION is set to FALSE, the PS services are also allowed for establishing RRC connection in addition to the CS services. Thus, according to the general concept of the 3GPP specification, without consideration of the emergency call, the CS services have a higher priority than the reception of the PWS messages, and the reception of the PWS messages has a higher priority than the PS services. In such a condition, several important PS services may have a lower priority, and several less important CS services may have a higher priority.

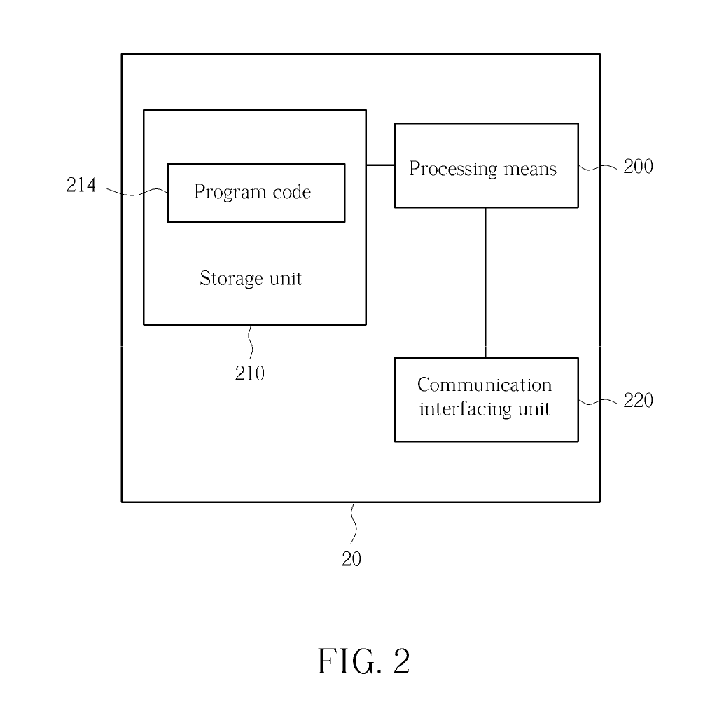

Please refer to FIG. 2, which is a schematic diagram of a communication device 20 according to an embodiment of the present invention. The communication device 20 may be used for realizing the network or the UEs shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 maybe any data storage device that can store a program code 214, accessed and executed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals (e.g., messages or packets) according to processing results of the processing means 200.

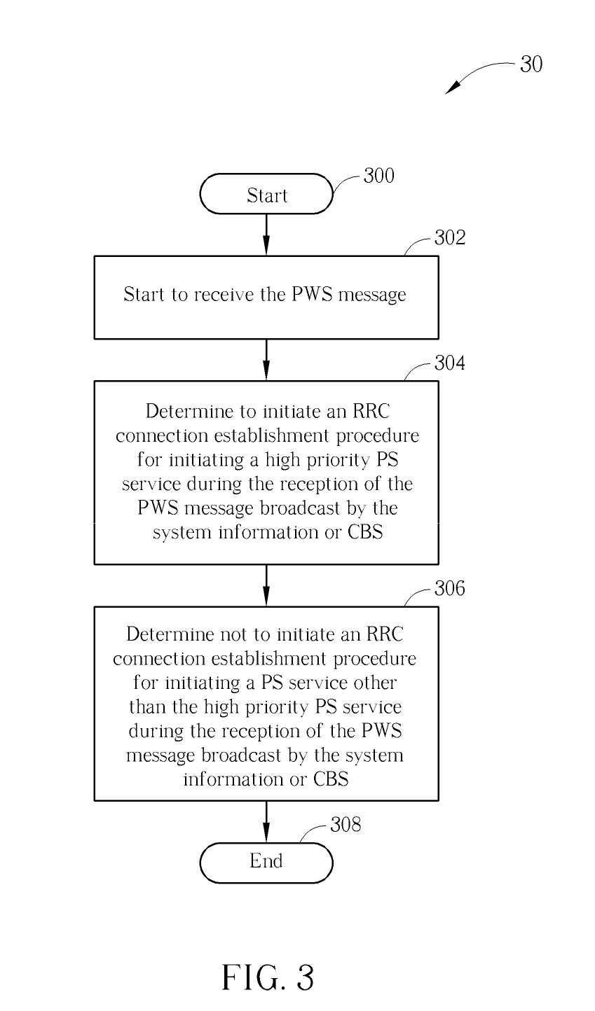

Please refer to FIG. 3, which is a flowchart of a process 30 according to an embodiment of the present invention. The process 30 may be utilized in a PWS capable UE of the wireless communication system 10 shown in FIG. 1, for handling RRC connection establishment during reception of a PWS message. The process 30 may be compiled into the program code 214 and includes the following steps:

Step 300: Start.

Step 302: Start to receive the PWS message.

Step 304: Determine to initiate an RRC connection establishment procedure for initiating a high priority PS service during the reception of the PWS message broadcast by the system information or CBS.

Step 306: Determine not to initiate an RRC connection establishment procedure for initiating a PS service other than the high priority PS service during the reception of the PWS message broadcast by the system information or CBS.

Step 308: End.

According to the process 30, the PWS capable UE determines to initiate the RRC connection establishment procedure for the PS service having a higher priority such as an IMS voice call, IMS video call or PS signaling transmission during the reception of the PWS message, wherein the PWS message is broadcast by the system information or CBS. In such a condition, a paging message may be received prior to the PWS message. The paging message (PAGING TYPE 1) indicating the reception of the PWS message may include the IE “ETWS information” and the IE “BCCH modification info” corresponding to the PWS message, so that the UE may set the variable BCCH_MODIFICATION_ACCESS_PROHIBITION to TRUE. When the PWS capable UE determines to initiate the RRC connection establishment procedure, the PWS capable UE terminates reception of the PWS message.

Please note that, even if the variable BCCH_MODIFICATION_ACCESS_PROHIBITION is set to TRUE, the UE determines to establish RRC connection for the high priority PS service such as the IMS voice call, the IMS video call or the PS signaling transmission. These PS services are generally regarded as high priority services and should not be postponed or prohibited due to the reception of the PWS message. For example, people who receive the warning notification in the PWS message may desire to make a phone call to inform their friends or relatives about the situation in disaster areas. Other people may also desire to make a phone call to their friends or relatives who live in the disaster areas, i.e. the IMS call may be initiated due to reception of a paging message. Therefore, both the IMS voice call and the IMS video call should not be postponed or prohibited. In addition, the PWS capable UE may need to perform an attach procedure or a routing area update procedure when moving between cells or routing areas. The paging message may not be received by the PWS capable UE if the attach procedure or the routing area update procedure is not complete after the PWS capable UE moves between cells or routing areas. Therefore, the PS signaling transmission including the attach request message or the routing area update request message may also be regarded as a high priority service and should not be postponed or prohibited due to the reception of the PWS message. On the other hand, the PWS capable UE determines to prohibit or postpone RRC connection establishment for a PS service which is not a high priority PS service until the reception of the PWS message finishes. The PS service may be an internet service such as web browsing, Facebook, Twitter, Plurk, messaging (e.g. WhatsApp and Line), YouTube or email.

In an embodiment, the PWS capable UE may include a notification in the RRC connection request message (e.g. by using establishment cause) to notify the network that this RRC connection is initiated for a high priority service. The network may allow the RRC connection when the notification meets the high priority definition. For example, for the IMS voice call or the IMS video call, the PWS capable UE may set an information element indicating the RRC establishment cause to “Originating Conversational Call” or “Terminating Conversational Call”, wherein “Originating Conversational Call” indicates initiation of a phone call and “Terminating Conversational Call” indicates reception of a phone call . For the high priority PS signaling transmission such as the attach request message and the routing area update request message, the PWS capable UE may set the information element indicating the RRC establishment cause to “High Priority Signaling” . Please note that the UE and the network may arbitrarily define which services have the high priority or 3GPP may specify which services have the high priority; this should not be limited herein.

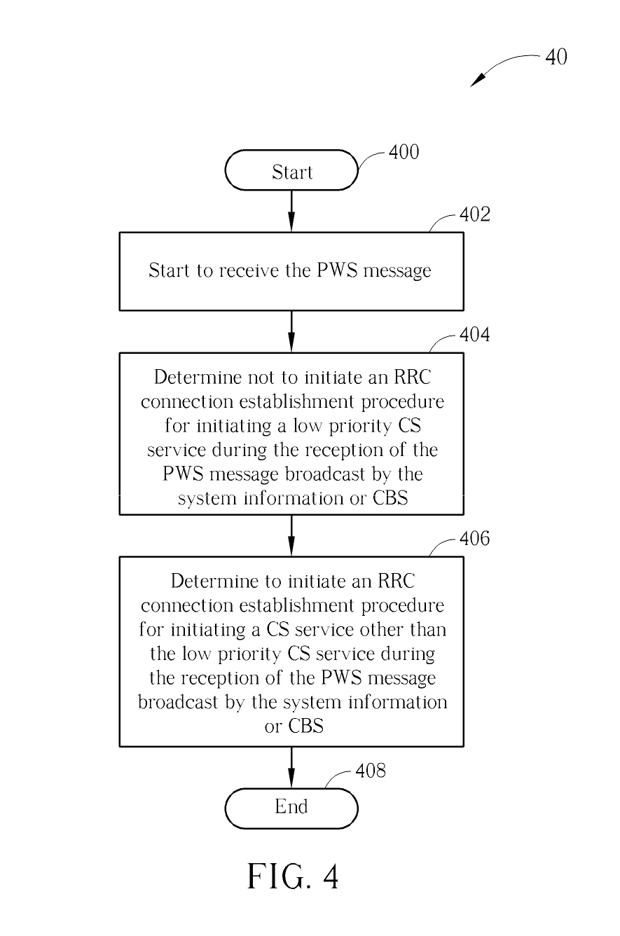

Please refer to FIG. 4, which is a flowchart of a process 40 according to an embodiment of the present invention. The process 40 may be utilized in a PWS capable UE of the wireless communication system 10 shown in FIG. 1, for handling RRC connection establishment during reception of a PWS message. The process 40 may be compiled into the program code 214 and includes the following steps:

Step 400: Start.

Step 402: Start to receive the PWS message.

Step 404: Determine not to initiate an RRC connection establishment procedure for initiating a low priority CS service during the reception of the PWS message broadcast by the system information or CBS.

Step 406: Determine to initiate an RRC connection establishment procedure for initiating a CS service other than the low priority CS service during the reception of the PWS message broadcast by the system information or CBS.

Step 408: End.

According to the process 40, the PWS capable UE determines not to initiate the RRC connection establishment procedure for initiating the CS service having a low priority during the reception of the PWS message, wherein the PWS message is broadcast by the system information or CBS. Such a low priority CS service may be a short message service (SMS). In general, when a natural disaster occurs, people may desire to make a phone call to communicate with their friends or relatives rather than sending a short message. In such a condition, the SMS should be regarded as a low priority service and should be postponed until the reception of the PWS message finishes. On the other hand, the PWS capable UE determines to initiate an RRC connection establishment procedure for initiating the CS service except the low priority CS service during the reception of the PWS message. The CS service except the low priority CS service may be a CS voice call, CS video call, or high priority signaling e.g. for transmitting location updating request.

In an embodiment, the PWS capable UE may include a notification in the RRC connection request message (e.g. by using establishment cause) to notify the network that this RRC connection is initiated for a low priority CS service. The network may not allow the RRC connection when the notification meets the low priority definition. For example, for the low priority service such as the SMS, the PWS capable UE may set an information element indicating the RRC establishment cause to “Low Priority Signaling”. Please note that the UE and the network may arbitrarily define which services have the low priority; this should not be limited herein. In another embodiment, the PWS capable UE may include a notification in the RRC connection request message (e.g. by using establishment cause) to notify the network that this RRC connection is initiated for a CS service other than the low priority CS service. The network may allow the RRC connection when the notification does not meet the low priority definition. For example, for the CS voice call, the PWS capable UE may set an information element indicating the RRC establishment cause to “Originating Conversational Call” or “Terminating Conversational Call” depending on the CS voice call is a mobile originated call or a mobile terminated call. Please note that the UE and the network may arbitrarily define which services have the low priority or 3GPP may specify which services have the low priority; this should not be limited herein.

In comparison with the prior art where all CS services have a higher priority than the reception of the PWS messages and the reception of the PWS messages has a higher priority than the PS services, the present invention allows the higher priority PS services to be performed by the PWS capable UE during the reception of the PWS message. In addition, the lower priority CS services are not allowed during the reception of the PWS message. Thus, the priority assignment of the PWS capable UE can be improved.

Those skilled in the art should readily make combinations, modifications and/or alterations on the abovementioned description and examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method of handling RRC connection establishment during the reception of the PWS message for a wireless communication system and a communication device thereof, which allow the PWS capable UE to receive a high priority PS service and prohibit/postpone a low priority CS service during the reception of the PWS message. In such a condition, the priority assignment of the PWS capable UE can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling radio resource control (RRC) connection establishment during reception of a public warning system (PWS) message for a user equipment of a wireless communication system, the method comprising:
starting to receive the PWS message;
determining to initiate an RRC connection establishment procedure for initiating a high priority packet-switched (PS) service during the reception of the PWS message broadcast by system information or a cell broadcast service (CBS); and
determining not to initiate an RRC connection establishment procedure for initiating a PS service other than the high priority PS service during the reception of the PWS message broadcast by the system information or the CBS.

2. The method of claim 1, further comprising:
receiving a paging message comprising at least one information element indicating the reception of the PWS message.

3. The method of claim 2, wherein the at least one information element comprises an information element indicating the PWS message and an information element indicating broadcast control channel (BCCH) modification.

4. The method of claim 3, wherein a variable BCCH_MODIFICATION_ACCESS_PROHIBITION is set to TRUE.

5. The method of claim 1, wherein the high priority PS service comprises an IMS voice call, an IMS video call or a PS signaling transmission.

6. The method of claim 5, further comprising:
setting an information element indicating an RRC establishment cause to “High Priority Signaling” for the PS signaling transmission.

7. A communication device of a wireless communication system for handling radio resource control (RRC) connection establishment during reception of a public warning system (PWS) message, the communication device comprising:
a processing means, for executing a program; and
a storage unit, coupled to the processing means, for storing the program which instructs the processing means to perform the following steps:
starting to receive the PWS message;
determining to initiate an RRC connection establishment procedure for initiating a high priority packet-switched (PS) service during the reception of the PWS message broadcast by system information or a cell broadcast service (CBS); and
determining not to initiate an RRC connection establishment procedure for initiating a PS service other than the high priority PS service during the reception of the PWS message broadcast by the system information or the CBS.

8. The communication device of claim 7, wherein the program further instructs the processing means to perform the following step:
receiving a paging message comprising at least one information element indicating the reception of the PWS message.

9. The communication device of claim 8, wherein the at least one information element comprises an information element indicating the PWS message and an information element indicating broadcast control channel (BCCH) modification.

10. The communication device of claim 9, wherein a variable BCCH_MODIFICATION_ACCESS_PROHIBITION is set to TRUE.

11. The communication device of claim 7, wherein the high priority PS service comprises an IMS voice call, an IMS video call or a PS signaling transmission.

12. The communication device of claim 11, wherein the program further instructs the processing means to perform the following step:
setting an information element indicating an RRC establishment cause to “High Priority Signaling” for the PS signaling transmission.

13. A communication device of a wireless communication system for handling radio resource control (RRC) connection establishment during reception of a public warning system (PWS) message, the communication device comprising:
a processing means, for executing a program; and
a storage unit, coupled to the processing means, for storing the program which instructs the processing means to perform the following steps:
starting to receive the PWS message;
determining not to initiate an RRC connection establishment procedure for initiating a low priority circuit-switched (CS) service during the reception of the PWS message broadcast by system information or a cell broadcast service (CBS); and
determining to initiate an RRC connection establishment procedure for initiating a CS service other than the low priority CS service during the reception of the PWS message broadcast by the system information or the CBS.

14. The communication device of claim 13, wherein the low priority CS service comprises a short message service.

15. The communication device of claim 13, wherein the program further instructs the processing means to perform the following step:
setting an information element indicating an RRC establishment cause to “Low Priority Signaling” for the low priority CS service.
